(19) United States
(12) Patent Application Publication
(10) Pub. No.: US 2014/0189760 A1
(43) Pub. Date: Jul. 3, 2014

(54) METHOD AND SYSTEM FOR ALLOCATING WIRELESS RESOURCES

(71) Applicants: CHARLES R. PAYETTE, MURRAY HILL, NJ (US); BRUCE R. CILLI, MURRAY HILL, NJ (US); GLEN R. BRUNS, NAPERVILLE, IL (US); ATUL DIVEKAR, NAPERVILLE, IL (US)

(72) Inventors: CHARLES R. PAYETTE, MURRAY HILL, NJ (US); BRUCE R. CILLI, MURRAY HILL, NJ (US); GLEN R. BRUNS, NAPERVILLE, IL (US); ATUL DIVEKAR, NAPERVILLE, IL (US)

(21) Appl. No.: 13/731,516

(22) Filed: Dec. 31, 2012

(51) Int. Cl. H04N 21/65

(52) U.S. Cl. CPC H04N 21/65
USPC 725/86

(57) ABSTRACT

A system and method for allocating wireless video resources among video streaming sources at an event (or events) according to a crowd selection mechanism.

### FIELD OF THE INVENTION

The invention relates generally to wireless communication networks, and more particularly to video transmission over an air interface in such networks.

### BACKGROUND

Wireless access links such as those provided by 3G and 4G networks are shared, limited resources. As a consequence, contention will arise when too many users attempt to transmit data from their mobile devices within the same sector. Until recently, users predominantly uploaded considerably less data than they would download. However, the recent introduction of video-enabled mobile devices is likely to stimulate rapidly growing demand for uplink bandwidth.

For this and other reasons, there is a growing need for flexible methods of video transmission that can provide enough quality to satisfy user needs while consuming relatively little bandwidth during times when resources are scarce, and that can provide higher quality when resources are more plentiful.

### SUMMARY

Various deficiencies in the prior art are addressed by embodiments for allocating wireless video resources among video streaming sources at an event (or events) according to a crowd selection mechanism.

A method according to one embodiment comprises receiving a user request to transmit a first video stream associated with an event of interest; identifying whether at least one other video stream is associated with the event of interest; enabling the requesting user to transmit the first video stream associated with the event of interest; and dynamically allocating wireless resources among the first video stream and the at least one other video stream associated with the event of interest.

### BRIEF DESCRIPTION OF THE DRAWINGS

The teachings herein can be readily understood by considering the following detailed description in conjunction with the accompanying drawings, in which:

FIG. 1 depicts an exemplary wireless communication system including an event server and application server according to an embodiment;

FIG. 2 depicts an exemplary event server suitable for use as the event server of FIG. 1;

FIG. 3 depicts an exemplary event server incorporating the application server as a software module according to an embodiment;

FIG. 4 depicts a flow diagram of a method for streaming video associated with an event according to one embodiment;

FIG. 5 depicts one embodiment of a method for dynamic allocation of resources according to one embodiment;

FIG. 6 graphically illustrates a protocol handshake for dynamic allocation of resources according to one embodiment; and

FIG. 7 depicts a high-level block diagram of a computer suitable for use in performing the functions described herein.

To facilitate understanding, identical reference numerals have been used, where possible, to designate identical elements that are common to the figures.

### DETAILED DESCRIPTION OF THE INVENTION

Embodiments of the invention will be primarily described within the context of an event server and application server adapted to allocate wireless video resources associated with network elements, communications links and the like within a Long Term Evolution (LTE) network. However, while primarily discussed within the context of managing wireless video resources associated with network elements supporting mobile services within an LTE network or portions thereof, those skilled in the art and informed by the teachings herein will realize that the various embodiments are also applicable to wireless video resources associated with other types of wireless networks (e.g., 3G networks, 2G networks, WiMAX, etc.), wireline networks or combinations of wireless and wireline networks in which finite bandwidth resources may be managed. Thus, the network elements, links, connectors, sites and other objects representing mobile services may identify network elements associated with other types of wireless and wireline networks.

The wireless video resource allocation capability enhances the capacity of a wireless cell to support the number of users in the cell who wish to stream video from (or to) their mobile devices. For example, the capacity of a cell (i.e., a wireless service area associated with a base station or eNodeB) may be insufficient to support the number of users at a sports event, entertainment event, scene of an accident or other emergency and the like who wish to stream (i.e., transmit or receive) captured video imagery via their mobile devices.

Different approaches to mitigate the issue are inadequate. For example, one solution is to increase the price of streaming wireless video when a wireless cell becomes congested. This approach is inadequate because payment plans for wireless users mostly require a fixed monthly fee, or a fixed price per bit. Many users are uncomfortable with making additional payments for use of a wireless cell when it is congested. Another approach is to block high-bandwidth users when a wireless cell becomes congested. This solution is inadequate because it makes users unhappy and does not consider that the content from users may vary in its value.

When many users located within the service area of a single cell wish to stream video simultaneously, it is possible that many of the users are videotaping the same event. Various embodiments provide for the apportionment of cell resources to streaming video users according to interest in the video streams by those watching the event. For example, one embodiment comprises a mechanism adapted to enable streaming video users to indicate an event being captured as video imagery such that interested viewers may discover and watch the video streams associated with an event and rate or rank each of these video streams. A mechanism associated with a wireless network operator, such as a base station scheduler, may use such rankings or rankings to help determine resources allocated to each streamed video and otherwise dynamically control each streamed video.

Although the video resource allocation capability is primarily depicted and described herein within the context of management of an LTE communications network, it will be appreciated that the video resource allocation capability may be used in any other suitable types of communication networks.

As used herein, the term “video” generally refers to encoded multimedia or video information (with or without corresponding audio information) such as captured by a video recording device associated with a mobile phone, computer or other communications device. This video or multimedia information is typically encoded according to any of a number of multimedia encoding/decoding, compression/decompression, transport or streaming protocols, such as AVI, MPEG, H.261 and the like. Similarly, the term “streaming” generally refers to substantially real time transmission or reception of a multimedia or video stream.

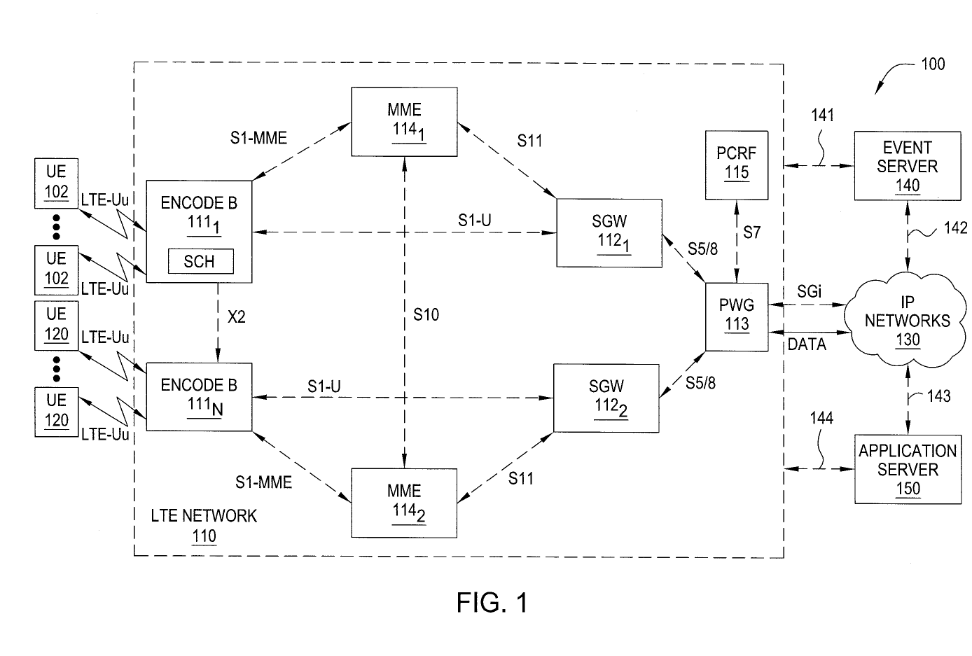

FIG. 1 depicts an exemplary wireless communication system including an event server and application server according to an embodiment. Specifically, FIG. 1 depicts an exemplary wireless communication system 100 that includes a plurality of User Equipment (UE) or User Devices (UDs) 102, 120, a Long Term Evolution (LTE) network 110, IP networks 130, an event server 140 and an application server 150.

The LTE network 110 supports communications between the UEs 102, and/or 120 a network such as a Long Term Evolution (LTE) network 110, one or more IP networks 130, an event server 140, an application server 150 as well as various other network communication and/or management elements (not shown).

The LTE network 110 supports communications between the UDs 102/120 and IP networks 130. The event server 140 is configured for supporting various operational and management functions for LTE network 110. The application server provides application software to UDs 102/120.

UDs 102/120 are wireless user devices capable of accessing a wireless network, such as LTE network 110. UDs 102/120 are capable of supporting control signaling in support of bearer session(s). UDs 102/120 may be a phone, PDA, computer, or any other wireless user device.

The general configuration and operation of a network such as LTE networks will be understood by one skilled in the art. The exemplary LTE network 110 includes a plurality of eNodeBs 111₁ through 111_{N} (collectively, eNodeBs 111), a plurality of Serving Gateways (SGWs) 112₁ and 112₂ (collectively, SGWs 112), at least one Packet Data Network (PDN) Gateway (PGW) 113, a plurality of Mobility Management Entities (MMEs) 114₁ and 114₂ (collectively, MMEs 114), and at least one Policy and Charging Rules Function (PCRF) 115. Various modifications to this configuration are known to those skilled in the art and are contemplated by the inventor as applicable to the various embodiments.

The eNodeBs 111, SGWs 112, PGW 113, MMEs 114, PCRF 115, as well as various LTE network components which have been omitted for purposes of clarity, cooperate to provide an Evolved Packet Core (EPC) network supporting end-to-end service delivery using IP. Other architectures and variations thereof are also contemplated by the inventors as supporting the embodiments.

The eNodeBs 111 provide radio access interface functions for the respective groups of UDs 102/120. As depicted in FIG. 1, each eNodeB 111 is associated with a base station scheduler SCH and supports a respective plurality of UDs 102/120. The communication between the eNodeBs 111 and the UEs 102/120 are supported using LTE-Uu interfaces associated with each of the UDs 102/120.

The SGWs 112 support communications for various pluralities of eNodeBs 111 using S1-u interfaces. The S1-u interfaces support per-bearer user plane tunneling and inter-eNodeB path switching during handover. It will be appreciated that the SGWs 112 may support more or fewer eNodeBs then indicated.

The PGW 113 supports communications for the SGWs 112 using respective S5/S8 interfaces. The S5 interfaces provide functions such as user plane tunneling and tunnel management for communications between PGW 113 and SGWs 112, SGW relocation due to UD mobility, and the like. The S8 interfaces, which may be Public Land Mobile Network (PLMN) variants of the S5 interfaces, provide inter-PLMN interfaces providing user and control plane connectivity between the SGW in the Visitor PLMN (VPLMN) and the PGW in the Home PLMN (HPLMN). The PGW 113 facilitates communications between LTE network 110 and IP networks 130 via, illustratively, an SGi interface.

The MMEs 114 provide mobility management functions in support of mobility of UDs 102/120. The MMEs 114 support the eNodeBs 111 using S1-MME interfaces, which provide control plane protocols for communication between the MMEs 114 and the eNodeBs 111.

The PCRF 115 provides dynamic allocation capabilities by which the service provider may manage rules related to services provided via LTE network 110 and rules related to charging for services provided via LTE network 110.

As depicted in FIG. 1, elements of LTE network 110 communicate with each other via various interfaces. The interfaces described with respect to LTE network 110 may also be referred to as sessions.

The LTE network 110 includes an Evolved Packet System/Solution (EPS). In one embodiment, the EPS includes EPS nodes (e.g., eNodeBs 111, SGWs 112, PGW 113, MMEs 114, and PCRF 115) and EPS-related interconnectivity (e.g., the S* interfaces, the G* interfaces, and the like). The EPS-related interfaces may be referred to herein as EPS-related paths.

The IP networks 130 include one or more packet data networks via which UDs 102/120 may access content, services, and the like.

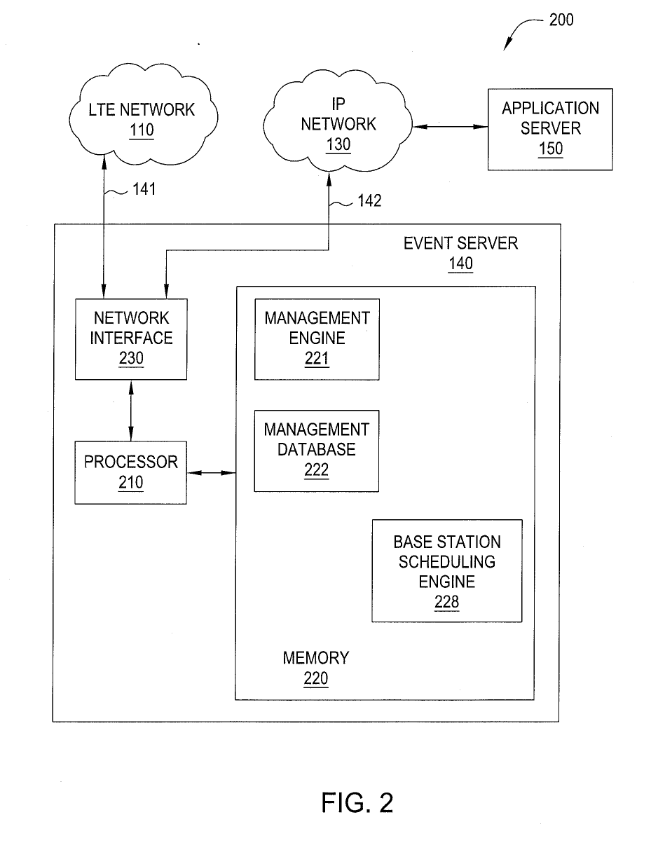

In various embodiments, the event server 140 provides operational functions for crowd selection and wireless video resource allocation in LTE network 110. The event server 140 may communicate with LTE network 110 in any suitable manner. In one embodiment, for example, event server 140 may communicate with LTE network 110 via a communication path 141 which does not traverse IP networks 130. In another embodiment, for example, event server 140 may communicate with LTE network 110 via a communication path 142 which is supported by IP networks 130. The communication paths 141 and 142 may be implemented using any suitable communications capabilities. An exemplary event server suitable for use as event server 140 of FIG. 1 is depicted and described with respect to FIG. 2.

In various embodiments, the event server 140 is adapted to manage the operations of above-described network elements including the UDs 102/120, eNodeBs 111, Serving Gateways (SGWs) 112, Packet Data Network (PDN) Gateway (PGW) 113, Mobility Management Entities (MMES) 114, and Policy and Charging Rules Function (PCRF) 115, as well as various other network elements (not shown), as well as the various communication links there between.

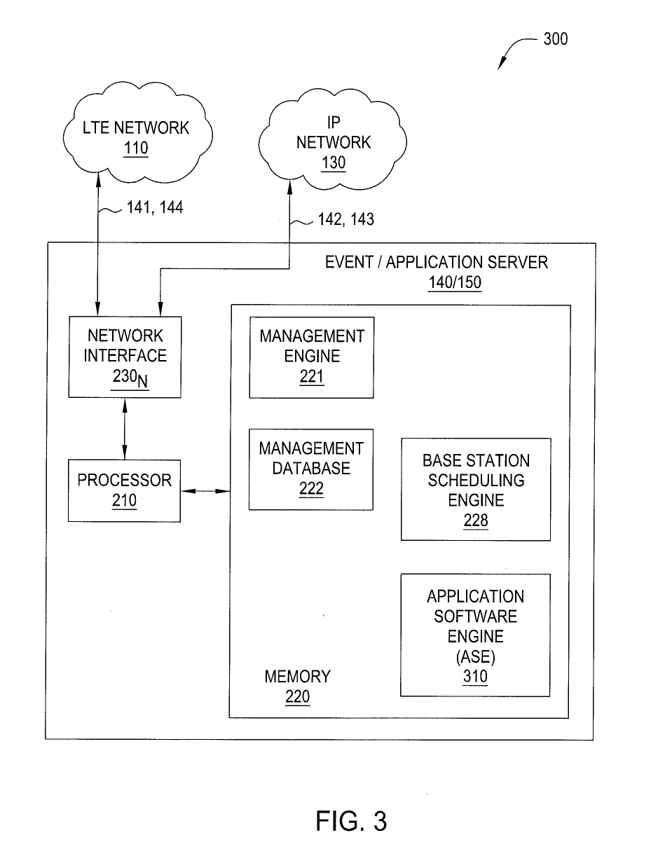

In various embodiments, the application server 150 provides application software such as for user devices 102/120 in LTE network 110. The application server 150 may communicate with LTE network 110 in any suitable manner. In one embodiment, for example, application server 150 may communicate with LTE network 110 via a communication path 143 which does not traverse IP networks 130. In one embodiment, for example, application server 150 may communicate with LTE network 110 via a communication path 144 which is supported by IP networks 130. The communication paths 143 and 144 may be implemented using any suitable communications capabilities. An exemplary application server is depicted and described with respect to FIG. 3.

The event server 140 and/or application server 150 may be in communication with an element management system (EMS), network management system (NMS) or other management entity (not shown). Generally speaking, the various management functions are adapted to manage the above-described network elements including the UDs 102/120 eNodeBs 111, Serving Gateways (SGWs) 112, Packet Data Network (PDN) Gateway (PGW) 113, Mobility Management Entities (MMEs) 114, and Policy and Charging Rules Function (PCRF) 115, as well as various other network elements (not shown) as well as the various communication links there between.

Various embodiments provide for the implementation of the event server and the application server. For example, in one embodiment, the event server and application server are implemented as standalone devices. In another embodiment, the application server is implemented as an Application Software Engine within the event server. This embodiment is depicted and described with respect to FIG. 3.

Referring to FIG. 1, it will be assumed for purposes of this discussion that at least one of the UDs 102 functions as a source user device by capturing audiovisual content associated with an event proximate the UD. That is, the source UD 102 captures audiovisual content via a built-in camera (i.e., an imaging device and related encoding circuitry, transport circuitry and the like) and streams or communicates packets representing the captured audiovisual content toward one or more destination UDs 102/120 via wireless/wireline infrastructure. It is assumed that a base station or eNodeB is supporting those UDs 102 streaming audiovisual content related to a geographically proximate event.

In various embodiments, the camera or other audiovisual capture circuitry within a user device encodes video and/or audio information at various levels of quality, which levels may be remotely controlled via an application interface or other technique. In this manner, system resources may be conserved (or preferentially allocated) by controlling one or more video encoding parameters of a user device.

While described herein in terms of source and destination smart phones or user devices, any internet-enabled device including a desktop computer, laptop computer, tablet computer, personal digital assistant (PDA), cellular telephone, wireless hotspot and the like capable of accessing the Internet may be used in terms of source and/or destination devices as described herein with respect to the various embodiments. Thus, while mobile phones are generally discussed within the context of the various embodiments, the use of any device having similar streaming functionality is considered to be within the scope of the present embodiments.

In operation, a source device 102 streams packets toward a destination device 120. The packets are transmitted from user device 102 to eNodeB 111 or base station via radio link between the source device 102 and base station or eNodeB 111. Base station or eNodeB 111 transmits the packets towards the network elements (equipment) within the LTE network 110, such as service gateways (SGWs) 112, packet gateways (PGWs) 113 and other provider equipment (PE), which in turn transmits the packets towards the destination user device 120 via an internal path or via one or more public networks 130 (e.g., the Internet). The one or more public networks 130 route the packets toward the equipment within a wireless provider network 110 (or portion thereof) associated with the destination user device 120. The equipment within the wireless provider network 110 transmits the packets to the destination smart phone 120 via a respective base station or eNodeB 111_{N}.

Base station or eNodeB 111_{N}, through its scheduler SCH, is instrumental in the delay and possible dropping of packets queued for uplink transmission of the packets depending on the network conditions and on the priority treatment requested for each of the respective packets. Base station or eNodeB 111_{N} similarly is instrumental in the delay and possible dropping of packets queued for downlink transmission to user device 120 because the received packets depend on the network conditions and on the priority treatment requested for each of the respective packets.

In one embodiment, the packets are not dropped; rather, the source device 102 is directed to encode video and/or audio at a lower bit rate based on an instruction communicated from application server 150.

Although described with respect to these two embodiments, other arrangement within the context of providing a minimum level of video quality to the users may be implemented.

Generally speaking, the user devices 102 comprise devices capable of capturing video imagery and transmitting corresponding video streams, or receiving such video streams. A service (application) provider provides application software for the user devices 102 and application server 150. The mobile service provider operates the mobile services network, including the user devices, the stations and backhaul equipment discussed herein.

In one embodiment, the application server communicates with the user devices 102/120 and video event server 140, which keeps track of the video streams being transmitted at each base station. In another embodiment, event server 140 keeps track of the event associated with each video stream. For dynamic allocation of resources to each streamed video, the wireless network or base station's scheduler is configured to support a feature to modify the allocated bit rate of the bearer of a video stream as it is underway. Additionally, a mechanism is implemented to inform the wireless user(s) of the change in bit rate.

FIG. 2 depicts an exemplary event server suitable for use as the event server of FIG. 1 for use in managing various wireless and wireline resources and interacting with UDs 102/120 to provide crowd selection and wireless video resource allocation in LTE network 110.

As depicted in FIG. 2, event server 140 includes one or more processor(s) 210, a memory 220 and a network interface 230. The processor(s) 210 is coupled to each of the memory 220 and the network interface 230, which are adapted to cooperate with memory 220, the network interface 230 and various support circuits to provide various management and operational functions for LTE network 110 such as described herein.

The memory 220, generally speaking, stores programs, data, tools and the like that are adapted for use in providing various management and operational functions for LTE network 110. The memory includes a Management Engine 221 (ME), a management database 222 (MD) and a Base Station Scheduling Engine (BSSE) 228.

In one embodiment, the ME 221 and BSSE 228 are implemented using software instructions which may be executed by processor (e.g., processor(s) 210) for performing the various management and scheduling functions depicted and described herein. In another embodiment, BSSE 228 is implemented as standalone device. Generally, the base station scheduler is configured to adjust the allocated bit rate of the bearer of the video stream.

The MD 222 stores data which may be generated by and used by various ones and/or combinations of the engines, functions and tools of memory 220.

Although depicted and described with respect to an embodiment in which each of the engines and databases are stored within memory 220, it will be appreciated by those skilled in the art that the engines and databases may be stored in one or more other storage devices internal to event server 140 and/or external to event server 140. The engines and databases may be distributed across any suitable numbers and/or types of storage devices internal and/or external to event server 140. The memory 220, including each of the engines and/or databases of memory 220, is described in additional detail herein below.

The network interface 230 is adapted to facilitate communications with LTE network 110.

As described herein, memory 220 includes the ME 221, MD 222 and BSSE 228, which cooperate to provide the various functions depicted and described herein. Although primarily depicted and described herein with respect to specific functions being performed by and/or using specific ones of the engines and/or databases of memory 220, it will be appreciated that any of the functions depicted and described herein may be performed by and/or using any one or more of the engines and/or databases of memory 220.

FIG. 3 depicts an exemplary event server 140 such as depicted and described above with respect to FIG. 2 and further incorporating the application server 150 as a software module according to an embodiment. The application software engine (ASE) 310 is generally adapted for providing application software to source devices 102 and destination (receiving) devices 120 in an LTE or other network 110.

In one embodiment, packets streamed from a source or sending device 102 (or other packet source) are not dropped unless absolutely necessary to avoid loss of service continuity; rather, the source or sending device 102 is directed to encode the stream at a lower bit rate based on communication from application software engine 310.

In another embodiment, application software engine (ASE) 310 is implemented as a standalone device operatively coupled to the various elements described herein.

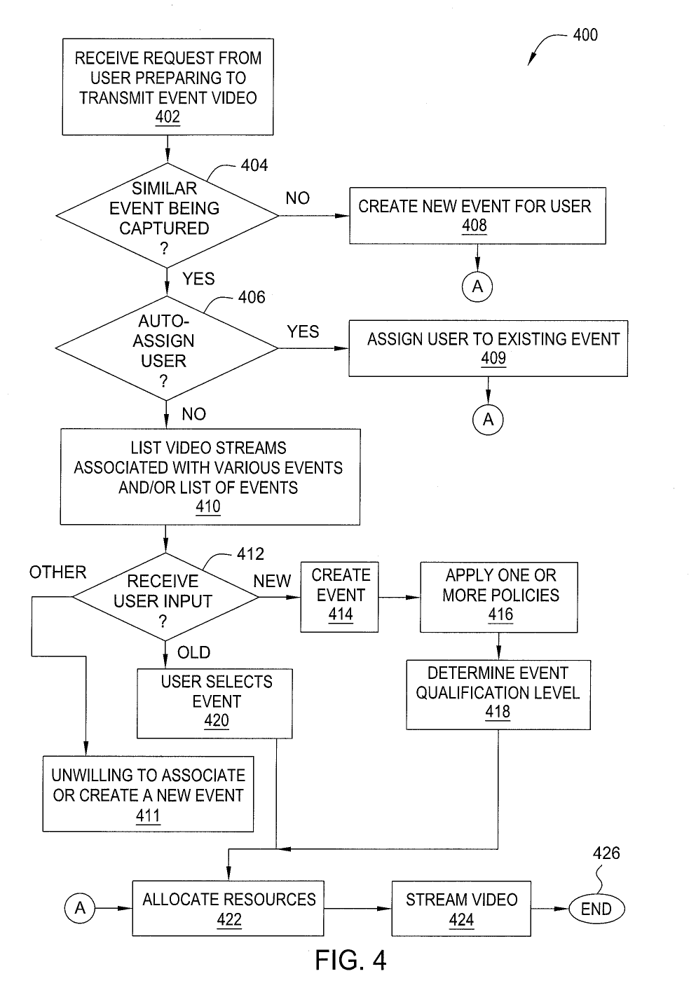

FIG. 4 depicts a flow diagram of a method for event bundling at a network element of a communication network. Generally speaking, the method 400 of FIG. 4 provides a mechanism for users to join an event (i.e., provide streaming video associated with an event), create a new event and the like. Various embodiments automatically join users to an event, while other embodiments allow user selection of this process.

At step 402, a request is received from a user preparing to transmit event video, such as from a sporting event, entertainment event and the like.

At step 404, a determination is made as to whether a similar event is presently being captured and streamed by another user. In various embodiments, this determination may be made via an event server search based on information such as event name, event location, user location and the like. This information may be explicitly provided by the user or determined by examining system information pertaining to the user (e.g., location information).

In various embodiments, this determination may be made via the user device, the event server, the application server or by some combination thereof. For example, a user may interact with software installed on a user device 102 to ascertain whether or not there are events already being recorded and whether the user is proximate one of those events. The application software may determine a current set or sets of events for a base station associated with the user by communicating with the mobile network provider's video event server 140 via the application provider's server 150.

If the query at step 404 is answered affirmatively, then the method 400 proceeds to step 406. If the query at step 404 is answered negatively, then the method 400 proceeds to step 408 where a new event is created for the user, and then to step 422.

At step 406, a determination is made as to whether the user is automatically assigned (i.e., joined) to the similar event being captured. That is, whether the user will be automatically joined to an event or allowed to select a specific event to join.

If the query at step 406 is answered affirmatively (i.e., user automatically joined to appropriate event of interest), then the method 400 proceeds to step 409 where the user is assigned to an existing event, and then to step 422. If the query at step 406 is answered negatively, then the method 400 proceeds to step 410.

At step 410, a list of video streams associated with various events and/or a list of events themselves are presented to the user. In various embodiments, a list of potential events and/or video streams is compiled by the event server and presented to the user via application software executed within the user device 102.

At step 412, a user input or interaction indicative of a selection is received, such as in response to a user being presented with the option to associate his/her video with an existing event.

If the user interaction received at step 412 is indicative of a user wishing to create a new event, then the method 400 proceeds to step 414, where a new event is created via user interaction or other means, to step 416 where one or more policies are applied to the newly created event, and to step 418 where a determination is made as to the level of qualification of the newly create event with respect to the policies. The method 400 then proceeds to step 422.

In various embodiments, the event related policies are selected via the application software on user device 102. In various embodiments, the event related policies are predefined or selected automatically based on various criteria.

Policies may comprise user type, locality, event type, number of events and the like. These categories may be applied individually or in some combination, e.g., favored users within a geographic area such as a sports stadium and the like. Generally speaking, policies are used to define resource utilization, permissions and/or other parameters such as according to any of user type, user location, event type, event location, total number of events, service level, system operating parameters and so on. Policies may defined at a central location and propagated out to one or more devices capable of policy-based management of various network operations, including instantiation of video streams.

In some user type embodiments, only a certain class of users is allowed to create an event. In this embodiment, the class of users comprises premium users, designated users, favored users and the like. Premium users are defined as users who have a paid version of the application. Designated users are users who are also agents for the company providing the service. Favored users are users who have high ratings based on winning videos and/or participation level.

Although described with respect to this class of users, other classes of users within the context of formulating policies may be implemented, such as based on the locality associated with the user where the user capturing video from within a specific geographic area is treated preferentially.

In an event type of embodiment, event creations are pre-screened and approved by applying decision tree criteria analytics and the like.

In a number of event type of embodiment, there is a limit placed upon the number of events from a particular geographic area. Such limit is predicated upon the available resources that may be allocated to a specific geographic area.

If the user interaction received at step 412 is indicative of a user wishing to be associated with an existing event, then the method 400 proceeds to step 420 where an existing event is selected by the user. The method 400 then proceeds to step 422.

If the user interaction received at step 412 is indicative of a user who does not wish to create a new event, and who also does not wish to select an old event to join, then user association with an event will be deferred until a later time. In some embodiments, the user is subsequently notified of new events as they occur and given the opportunity to join an event. In other embodiments, a user may periodically query the event server regarding the occurrence of a new event of interest.

At step 422, resources are allocated for the event in accordance with various policies such as an association with a particular user type, locality, event type, number of events and the like. At step 424, the user then begins recording the event, and the audiovisual recording is streamed to the network via the base station and the mobile network. At step 426, method 400 ends.

Although primarily depicted and described hereinabove with respect to an embodiment in which video streaming capability is provided by using a combination of application software installed on users devices, an event server and an application server, it will be appreciated that in other embodiments only the event server may be used or only the application server or only the application software feature may be used.

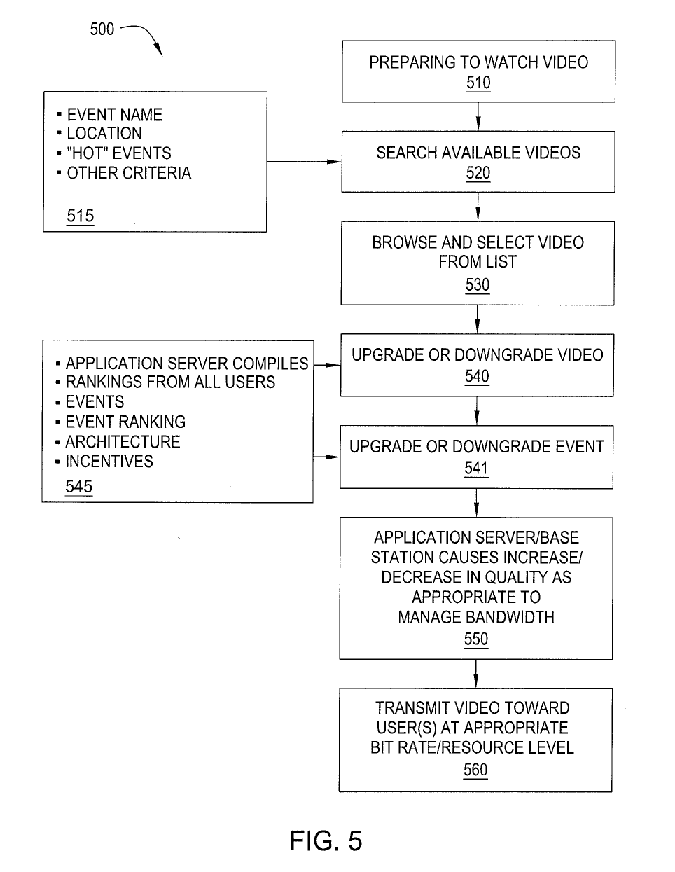

FIG. 5 depicts a method for dynamic allocation of resources according to one embodiment. Specifically, the event server 140 and/or application server 150 communicates with the wireless network to adjust the allowable bit rate of each of the streams as appropriate. Additionally, the user's device that is sending the video is informed via the base station or other means that its allocated bit rate has been modified. The encoder of the sending device then dynamically adjusts its coding to meet the new bit rate.

At step 510, user/s prepare to watch a video of interest. User/s who wish to watch videos may search for events, such as by using application software on their user device/s 120.

At step 520, a search of available videos is performed. Referring to box 515, the search may be based on one or more of an event name, an event location, a user location and the like. Additional search features could allow users to search for “hot” events, which are events for which many users have recently started sending video.

At step 530, the user is provided with a list of available videos to browse and an opportunity to select a video of interest. The application software installed on the device/s of user/s watching the video determines current events using the mobile service provider's video event server 140, via application server 150.

Once a user has selected an event to watch, the videos associated with the event are displayed on the user's device. The application software provides a means for the user to browse through all videos associated with the event, and to rate or rank the videos according to the user's level of interest.

Application server 150 compiles the rankings from all users that are watching the videos associated with an event, and then communicate with the video event server 140 to “upgrade” or “downgrade” videos. An event may similarly be ranked.

At step 540, video streams may be upgraded or downgraded based on the ratings obtained from users and/or other sources.

At step 541, events are may be upgraded or downgraded based on the ratings obtained from users.

Referring to box 545, the upgrade/downgrade of steps 540 and 541 may be based on user (or other) ratings compiled by the application server 150, event type, event rank, architecture, various incentives (e.g., paid placements) and other considerations.

At step 550, event server 140 communicates with the base station's scheduler SCH to increase or decrease the quality of videos being streamed (and therefore the bandwidth consumption) through the base station by adjusting the allowable bit rate of one or more of the streams. In various embodiments, the allowable bit rate of one or more streams is controlled by adapting encoding parameters at one or more client devices. The encoding parameters may be communicated to the one or more client devices via a base station, application server, event server or some other entity. For example, in an LTE embodiment, this communication may be provided via a request to the PCRF which would adjust the bit rates via standard 3GPP signaling for bearer modification.

Allowable bitrate may be adjusted by dropping encoded video frames or by reducing the amount of data necessary to encode a video frame (i.e., adapting video encoding parameters).

Video encoding parameters that may be adjusted to encode video at a target bit rate include one or more of video resolution, frame rate, frame size, pixel density, color density, motion capture accuracy, group of frames (GOP) or group of pictures (GOP) structure and the like. Thus, highly-rated videos would be transmitted with higher quality (e.g., high definition), and lower-rated videos are transmitted with lower quality (e.g., standard definition). As a result, the users watching the video stream imagery on their devices will see the videos associated with an event at different levels of quality depending upon encoding quality level, which in turn is selected according to wireless resource allocation. Similar modifications may be made to related audio encoding parameters.

A user device that is sending video is informed via the base station or via other means that a bit rate allocated thereto has been modified, such as via a control signal communicated via the application. In this case, the user application causes the adaptation of the encoder of the sending device to dynamically adjust its coding to meet the new bit rate. Optionally, the recording/streaming is terminated and restarted using new encoding parameters.

In another embodiment, users may rate events as well as videos. If an event is upgraded, then all video streams associated with that event are upgraded. Similarly, if an event is downgraded, then all video streams associated with that event are downgraded.

As an event continues, users may tend to prefer one view over another, and may modify their ratings, in turn causing the relative quality of video associated with the event to further evolve. Thus, videos that are not receiving favorable treatment are encoded such that these videos are not rejected simply based on their perceived poor quality. One way to mitigate this issue is to send a low resolution video displayed in a smaller window. This approach involves a plurality of scenarios, including (1) a scenario associated with the events; (2) a scenario associated with ranking of the events; (3) a scenario associated with the architecture of the system; and (4) a scenario associated with incentives for users.

(1) Events—more than one event may originate from the same cell sector. For example, there may be a surfing competition (event A) occurring on an adjacent beach to a volleyball tournament (event B). A system is required to manage the available resources such that the video streams from event A and the video streams from event B are treated in a “fair” manner according to the policy of the wireless network operator.

In one embodiment, event A and event B are allocated resources in proportion to the number of video streams that are contributing to that event. The policy may also determine whether a user may create a new event duplicative of either event A or event B.

(2) Event ranking—all viewers of an event may not necessarily have an equal vote in the video's rank. For instance, the vote from a person using a paid version of the application may have a higher weight than the vote from a person using the free version of the application. Also, a video's rank may be affected by attributes of the sender, such as the sender's popularity or reputation and the like.

(3) Architecture—In this scenario, an “over the top” (OTT) architectural implementation is contemplated. The application owner may manage the event server in addition to the application server. Additionally, the application server can be configured to only notify the video sending devices of adjustments to bit rate (quality). Further, all video sessions may only receive “Best Effort” service leading to an unpredictable quality of experience for the video viewers, because the service provider network is not aware of these procedures.

(4) Incentives—A regime of incentives to encourage individuals to share their videos publicly is contemplated in this embodiment. Users are already willing to upload their videos to sites such as YouTube; however, providing incentives may still be important for certain applications. These incentives may be in the form of monetary reward, on-line popularity or possibly the waiving of monthly usage caps for applicable video sessions and the like, as well as various combinations thereof.

In another embodiment, bandwidth may be bounded by a lower limit, which ensures that a streamed video is shown with a minimum quality level.

At step 560, the video is transmitted towards the user/s at an appropriate bit rate or resource level.

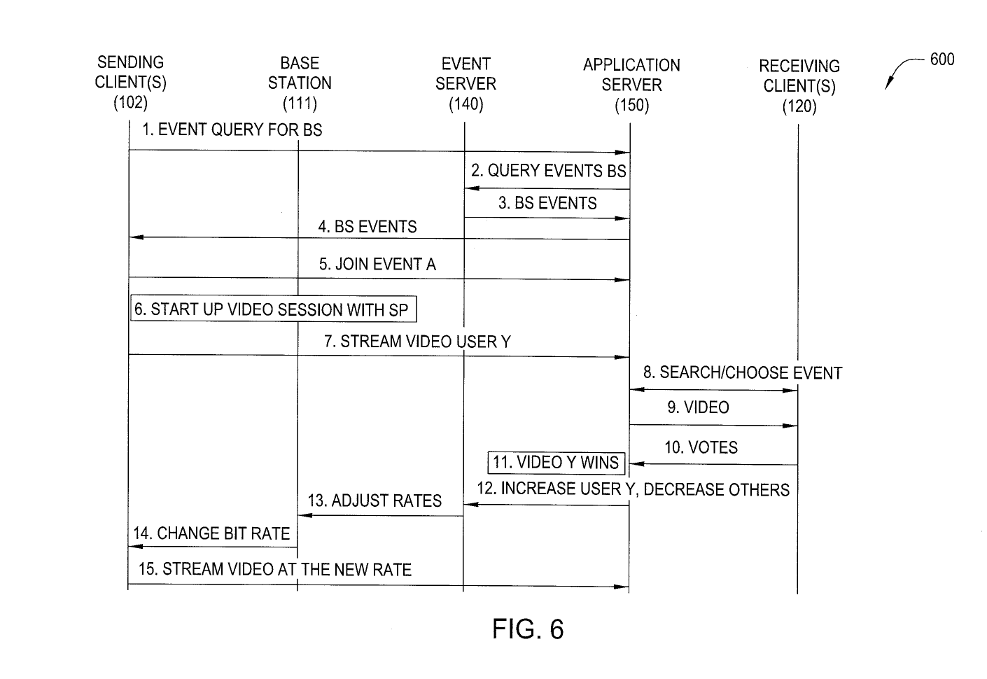

FIG. 6 graphically illustrates a protocol for dynamic allocation of resources according to one embodiment.

At step 1, sending client 102 queries application server 150 for events already being captured as video imagery.

At step 2, application server 150 queries event server 140 associated with the base station 111.

At step 3, event server 140 replies to application server 150 with a list of events, if any, being captured as video imagery.

At step 4, application server 150 replies to client 102 providing the result of the search.

At step 5, client 102 requests to join a specific event.

At step 6, the new video session begins.

At step 7, client 102 starts recording the video session.

At step 8, receiving (viewing) client 120 requests to view a video associated with one or more events. The application server searches one or more portions of video related to one or more events being streamed in the communication network. The result of the search can be provided to receiving (viewing) client 120 to thereby allow receiving (viewing) client 120 to select an event of interest being streamed.

At step 9, application server 150 provides receiving (viewing) client 120 with videos associated with the event of interest being streamed.

At step 10, application server 150 receives a plurality of rankings for a specific video being viewed and compiles said rankings.

At step 11, the event with the highest ranking is determined (e.g., wins).

At step 12 application server commands event server to upgrade or downgrade the specific video being viewed based on the compiled rankings.

At step 13, the BSSE 228 of event server 140 communicates with the base station (e.g., base station scheduler SCH) to adjust the bit rate and allocate other resources accordingly.

At step 14, the base station communicates with client device to change the bit rate.

At step 15, client device 102 starts streaming at the new rate.

Various modifications to the above-describe steps and functional elements of the various figures are contemplated by the inventors as described herein.

Resource allocation among the various user devices is adapted to ensure, to the extent possible, that each user device is allocated resources appropriate to the video imagery captured and streamed thereby. For example, those user devices from which higher-quality video streams are to be provided must be allocated additional resources as compared to those user devices from which lower quality video streams are to be provided.

Resource allocations are optionally policed by various mechanisms at an eNodeB/base station 111, SGW 112 or other routing mechanism within the network. Various policing mechanisms are known to those skilled in the art and will not be discussed in detail here. Generally speaking, it is preferable to adapt resource utilization at the user device level so that policing mechanisms are not later invoked since post-encoded video streams subjected to policing may include visual artifacts such as frozen frames, pixelation and the like which are undesired by the viewer.

The various mechanisms, methodologies and the like described herein may be modified according to various other embodiments. For example, various embodiments provide that, illustratively, the BSSE 228 operates to notify a base station scheduler SCH or other entity that a bit rate or other quality level associated with one or more video streams should be modified. In various other embodiments, such notification may be sent directly to user devices. Thus, in various embodiments, control messages adapted to cause changes to user device video capture/streaming encoding parameters, bit rate utilization, and/or other qualitative parameters may be provided directly to the user devices operative to capture video imagery, encode the video imagery and transmits resulting video streams, or to one or more base stations supporting such user devices.

Various embodiments contemplate event server 140 and application server 150 interactions with either or both of the base stations 111 and user devices 102/120. For example, event server 140 (e.g., base station scheduling engine 228) may operate to notify both base stations and user devices of bandwidth constraints or other qualitative limits. Thus, an event server 140 may provide such notifications to a base station 111, user devices 102 or both. In various embodiments, the application server 150 may notify event server 140, one or more base stations 111, and one or more user devices 102/120 of changes associated with various application parameters.

In various embodiments, the mechanism to determine bit rate allocations may be implemented at any of the event server 140, application server 150 and eNodeB/base station 111. Various embodiments, this mechanism may be implemented at a network management system (NMS), element management system (EMS) or other management entity. Generally speaking, the bit rate allocation mechanism is responsive to video stream voting results as defined by viewer count, viewer rating and/or other methodologies such that preferential resource allocation is provided to more frequently viewed or higher rated video streams.

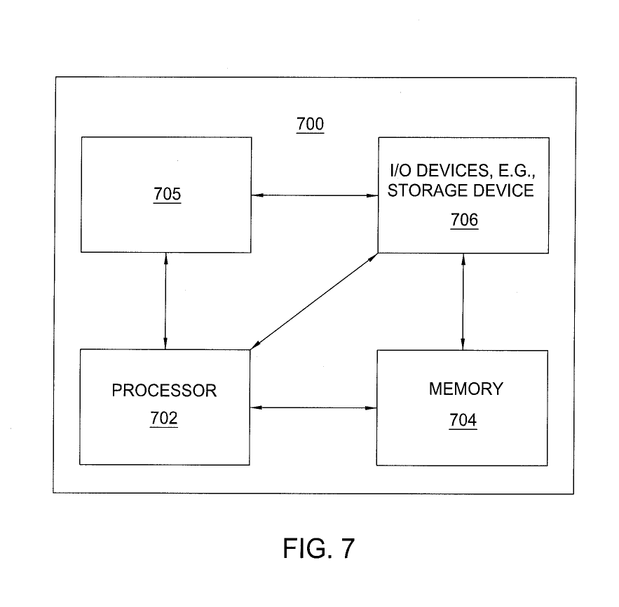

FIG. 7 depicts a high-level block diagram of a computer suitable for use in performing functions such as described above with respect to UDs 102/120, servers 140/150 and network elements.

As depicted in FIG. 7, computer 700 includes a processor element 702 (e.g., a central processing unit (CPU) and/or other suitable processor(s)), a memory 704 (e.g., random access memory (RAM), read only memory (ROM), and the like), a cooperating module/process 705, and various input/output devices 706 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that computer 700 depicted in FIG. 7 provides a general architecture and functionality suitable for implementing functional elements described herein or portions network of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

While the foregoing is directed to various embodiments of the present invention, other and further embodiments of the invention may be devised without departing from the basic scope thereof. As such, the appropriate scope of the invention is to be determined according to the claims.

1. A method, comprising:
receiving a request to transmit a first video stream from a first user device of video imagery being captured at an event of interest;
determining if another video stream is associated with the event of interest and being transmitted;
enabling the first user device to transmit the first video stream; and
dynamically allocating wireless resources allocated to the event of interest among the first video stream and the at least one other video stream associated with the event of interest.

2. The method of claim 1, wherein said
determining comprises searching for other video streams associated with the event of interest according to one or more of an event name, an event location and a user location.

3. The method of claim 2, wherein the searching comprises searching related events proximate a geographic area.

4. The method of claim 1, further comprising:
in response to a determination of another video stream not being associated with said event of interest, enabling the user to create a new event according to one or more policies, and determining a resource allocation level for the new event.

5. The method of claim 4, wherein the one or more policies define resource utilization and permission parameters according to one or more of user type, user location, event type, event location and total number of events.

6. The method of claim 5, wherein user type comprises any of premium user type, designated user type and favored user type, wherein each user type is associated with one or more of a service level and a permissions level.

7. The method of claim 1, wherein dynamically allocating wireless resources is performed based on a ranking of video streams associated with the event of interest.

8. The method of claim 7, wherein the ranking of said video streams associated with said event is based upon a number of viewer requests for said video streams.

9. The method of claim 7, wherein ranking of said video streams associated with said event is based upon user ratings of one or more of respective video streams, event ranking, architecture and incentive.

10. The method of claim 1, wherein dynamically allocating wireless resources of a respective video stream comprises adapting one or more encoding parameters.

11. The method of claim 10, wherein said one or more encoding parameters comprise one or more of video resolution, frame rate, frame size, pixel density, color density and group of frames (GOP) structure.

12. The method of claim 10, wherein said one or more encoding parameters comprise one or more parameters associated with a high definition video encoding or a standard definition video encoding.

13. The method of claim 10, wherein encoding parameters within a user device are adapted by controlling video capture circuitry within the user device via an application within the user device.

14. A system for managing wireless resources for streaming video, comprising:
an application server adapted to communicate with a plurality of user devices streaming video via a base station having an associated base station scheduler for allocating wireless resources; and
an event server adapted to store, for each of one or more events, an identifier for identifying video streams associated with the event and a number of viewers of each video stream;
said application server causing said base station scheduler to dynamically allocate wireless resources allocated to a respective event of interest among video streams associated with the respective event of interest in response to a ranking of said video streams associated with the respective event of interest.

15. The system of claim 14, wherein the ranking of said video streams is determined according to at least one of a number of video stream viewers and a rating provided by said video stream viewers.

16. The system of claim 14, wherein wireless resources are preferentially allocated to higher ranking video streams.

17. The system of claim 14, wherein said application server communicates one or more video encoding parameters to a user device generating a video stream, said communicated video encoding parameters adapted to cause said user device to encode said video stream at a target bitrate.

18. The system of claim 17, wherein said application server adapts a target bitrate of user devices associated with a plurality of events supported by a base station in response to a ranking of said events.

19. A non-transitory computer readable medium including software instructions which, when executed by a processor, perform a method comprising:
receiving a request to transmit a first video stream from a first user device of video imagery being captured at an event of interest;
determining if another video stream is associated with the event of interest and being transmitted;
enabling the first user device to transmit the first video stream; and
dynamically allocating wireless resources allocated to the event of interest among the first video stream and the at least one other video stream associated with the event of interest.

20. A computer program product, wherein a computer is operative to process software instructions which adapt the operation of the computer such that computer performs a method, comprising:
receiving a request to transmit a first video stream from a first user device of video imagery being captured at an event of interest;
determining if another video stream is associated with the event of interest and being transmitted;
enabling the first user device to transmit the first video stream; and
dynamically allocating wireless resources allocated to the event of interest among the first video stream and the at least one other video stream associated with the event of interest.

21. The method of claim 1, further comprising:
receiving a request to transmit a second video stream from a second user device of video imagery being captured at a second event of interest; and
in response to said second event of interest not being associated with other video streams, enabling the user to create a new event according to one or more policies, and determining a resource allocation level for the new event.

22. The method of claim 1, further comprising:
in response to said event of interest being associated with the one or more other video streams, joining said first video stream to said event of interest according to one or more policies associated with said event of interest.
